(19) United States
(12) Patent Application Publication
(10) Pub. No.: US 2021/0212265 A1
(43) Pub. Date: Jul. 15, 2021

(54) MODULAR FLOWER PANEL ADAPTER SYSTEM

(71) Applicant: Hans Chang, Houston, TX (US)

(72) Inventor: Hans Chang, Houston, TX (US)

(21) Appl. No.: 16/739,764

(22) Filed: Jan. 10, 2020

(51) Int. Cl. A01G 5/04; A01G 9/20

(52) U.S. Cl. CPC A01G 5/04; A01G 9/20

(57) ABSTRACT

A modular flower panel adapter system is implemented in which individual flower panels are collectively utilized to hold and feature an arrangement of flowers. The flower panels, which are already holding an arrangement of flowers, are transportable using an adapter panel and a delivery cage. The adapter provides greater surface area for transportation and handling of the flower panel. A rack system and delivery cage are implemented to transport the combined unit of the flower panel and the adapter panel to an event. At the event, the adapter panel is disconnected and the flower panel is connected to a structural panel and support panel for assembly. Multiple structural panels are connected together using connectors, and each structural panel is attached to an individual flower panel for exhibition. A collection of flower panels laterally and adjacently positioned create a robust and customizable flower wall arrangement that is easily transportable and assembled.

### BACKGROUND

Flower arrangements can be requested for various kinds of special events, such as weddings, funerals, and birthday parties. Party organizers sometimes request vast flower arrangements that can take up an entire or portion of a wall to provide the aesthetic appearance of a wall made of flowers. Creating these vast floral arrangements can take significant time and effort, such as to delicately arrange the flowers and to transport a completed arrangement without causing damage to the flowers.

### SUMMARY

A modular flower panel adapter system is implemented in which individual flower panels are collectively utilized to hold and feature an arrangement of flowers. Flower panels which are already holding and assembled with an arrangement of flowers are transportable using an adapter and a delivery cage. The adapter panel is larger than the flower panel to provide greater service area around a perimeter of the flower panel for transporting and handling, and thereby reduce the amount of inadvertent damage to the flowers in the flower panel. The flower panel secures to the adapter using some connector mechanism, like bolts and nuts. The adapter and flower panel unit are loaded into a slot of a rack system within the delivery cage. The rack system may have multiple slots and sections to hold and transport multiple units of adapters and flower panels.

After unloading the flower panels and detaching them from their respective adapter panels, the flower panels can be exhibited at the event's location by setting up a grid cage which is comprised of a series of structural panels. In typical implementations, the structural panels may be wire grid panels comprised of a series of grid elements that run up and down and left to right. The structural panels are connected together using a connector that attaches to a corner of the structural panels. In typical implementations, the connector has multiple receptacles that receive the corner pieces of the wire elements for adjacently positioned structural panels. When fully assembled, the structural panels can create a large display area to receive and feature the flower panels. For example, each structural panel may be connected to a single flower panel. To provide additional support, a support panel may be positioned on a rear of the structural panel and to which a flower panel fastens. The flower panel includes connector holes through which a bolt extends, travels through the structural panel, and is fastened into the support panel.

The modular flower wall system enables a company to assemble large numbers of flower panels at a facility and easily select and transport a necessary number of flower panels to a given event. This can increase the number of output from the facility and streamline the overall process—from creation of the floral arrangements to delivery and assembly of the robust floral setup. Furthermore, use of the structural panels and grid cage enables an easy setup that otherwise may have been difficult if not for the ecosystem of components working together from the facility that creates the flower panels to the event's location.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. These and various other features will be apparent from a reading of the following Detailed Description and a review of the associated drawings.

### DESCRIPTION OF THE DRAWINGS

FIG. 1 shows an illustrative representation of a flower panel which is used to display an arrangement of flowers;

FIG. 2 shows an illustrative representation of a flower panel from a side view to show a receptacle;

FIG. 3 shows an illustrative representation of two flower panels adjacently positioned and a connector used to connect the panels together;

FIG. 4 shows an illustrative representation of a rear side of the flower panel;

FIG. 5 shows an illustrative representation of the flower panel connector aligned with the receptacle;

FIG. 6 show an illustrative representation of the two flower panels connected to each other;

FIG. 7 shows an illustrative representation of the flower panel connecting to an adapter panel for transporting and handling;

FIG. 8 shows an illustrative representation in which the adapter panel provides greater surface area for handling and transporting the flower panel;

FIG. 9 shows an illustrative representation in which a delivery cage is utilized with a rack system to transport multiple units of flower panels and adapters;

FIG. 10 shows an illustrative representation in which the flower panels with adapters are inserted into slots of the rack system;

FIG. 11 shows an illustrative representation of an exploded view of an assembly of the flower panel, structural panel, and support panel;

FIG. 12 shows an illustrative representation of the assembled flower panel, structural panel, and support panel from a side view;

FIG. 13 shows an illustrative representation in which a connector can be used to connect structural panels together;

FIG. 14 shows an illustrative representation in which the connector is attached to a structural panel;

FIG. 15 shows an illustrative representation in which a set of a flower panel and structural panel are attached to another set of a flower panel and structural panel;

FIG. 16 shows an illustrative representation in which a grid cage is created using a series of connected structural panels; and

FIG. 17 shows an illustrative representation of flower panels attached to the assembled grid cage.

Like reference numerals indicate like elements in the drawings. Elements are not drawn to scale unless otherwise indicated.

### DETAILED DESCRIPTION

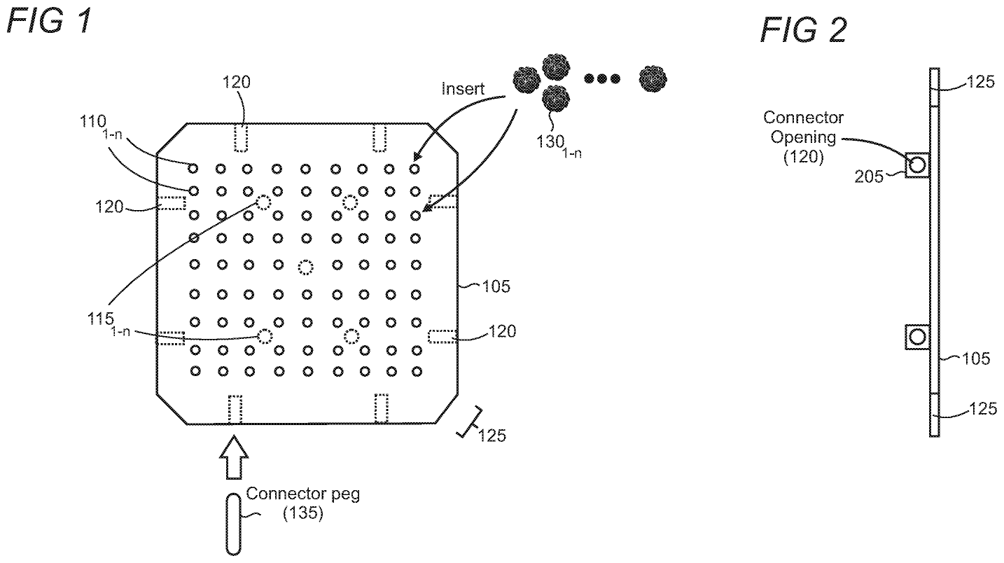

FIG. 1 shows an illustrative representation of a flower panel 105 having holes 110 into which flower stems (not shown) can be inserted to feature a collection of flowers 130. In this implementation, the holes are evenly spaced and arranged in parallel from left to right and up to down. In other implementations, the holes may be randomly dispersed or arranged to portray a message or shape, such as the shape of a face, letter, number, symbol, etc.

Connector holes 115 are dispersed on the flower panel 105 to enable connecting of the flower panel to another structure, such as a support panel, as discussed in greater detail below. In this example, the connector holes are positioned between and among the holes 110, but in other implementations, the connector holes may be positioned additionally or alternatively near the corners or at other locations throughout the flower panel. As discussed in greater detail below, the flower panel 105 is structured with edged corners 125 that are cut-out to accommodate a connector that enables a plurality of flower panels to be adjacently positioned to create a wall of flowers.

A cylindrical connector peg 135 can be inserted into a receptacle 120, as shown in FIGS. 1 and 2, to attach two flower panels together. The receptacles are positioned on respective shafts 205 which are attached to a rear of the flower panel using, for example, adhesive, screws, bolts, etc., or any combination thereof. The screws or bolts used to secure the shafts 205 to the rear of the flower panel may be distinct from or in addition to the bolts that are inserted in connector holes 115. In this implementation, the shafts and holes are separately attached to a rear of the flower panel. In other implementations, the connector holes can be carved out on a side of the flower panel itself. The connector peg can be any one or more of a friction fit mechanism, a tab and notch mechanism, or other connecting mechanism. The size and shape of the receptacle and corresponding connector peg can vary based on the implementation, and can alternatively be square, triangle, or oval shaped.

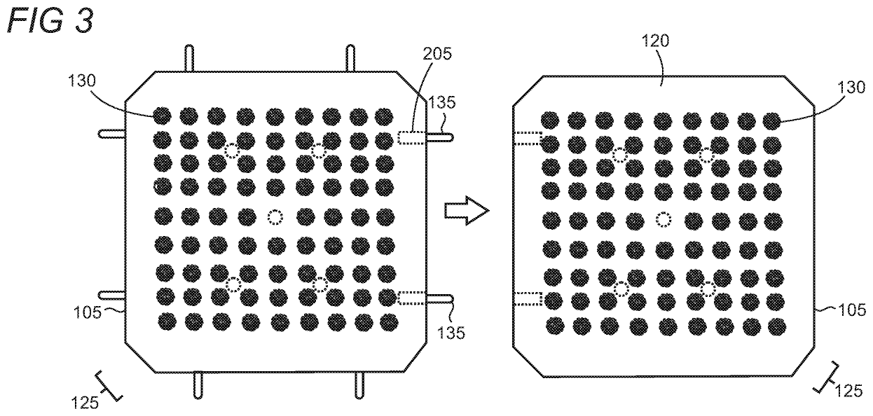

FIG. 3 shows an example of two aligned flower panels 105 that are filled with flowers to create an aesthetic appearance of a flower wall. The connector pegs can be inserted into one of the flower panel's connector holes 120 and the other half or portion of the connector peg inserts into an adjacent flower panel to secure the flower panels together. This can help with alignment and consistency when a wall of flowers is created.

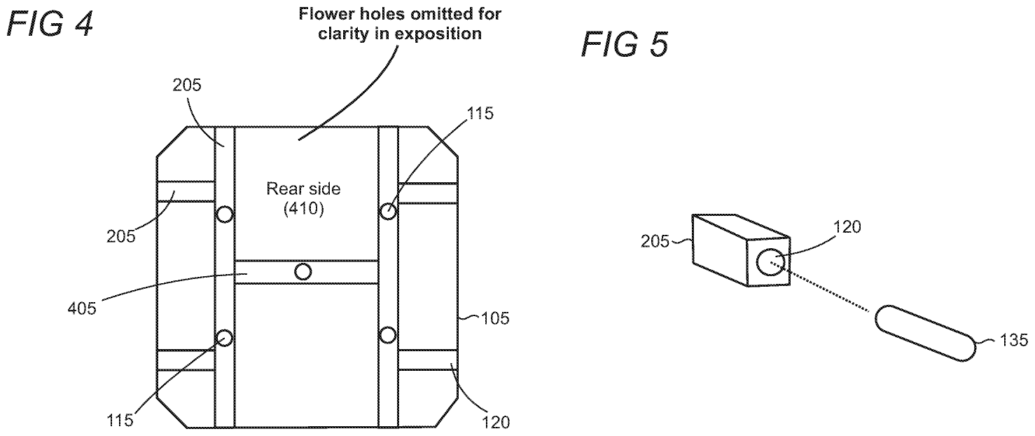

FIG. 4 shows an illustrative representation of a rear side 410 of the flower panel 105. The flower panel includes long shafts and short shafts on which are the connector holes 120 (not shown) are positioned. The long shafts extend from opposing sides of the flower panel and the short shafts extend perpendicular from the long shafts, so that holes are arranged on each side of the flower panel. Connector holes 115 extend from the flower panel (FIG. 1) through the shafts 205. Support element 405 is utilized to connect the two long parallel shafts together and to provide a consistent plane for other panels to connect to a rear of the flower panel, as discussed in greater detail below.

FIG. 5 shows an illustrative representation of the connector peg 135 aligned with the receptacle 120 on the shaft 205. In typical implementations, the connector peg will insert approximately halfway into the receptacle so that the other half of the peg can be inserted into an adjacent flower panel to thereby connect the two flower panels together.

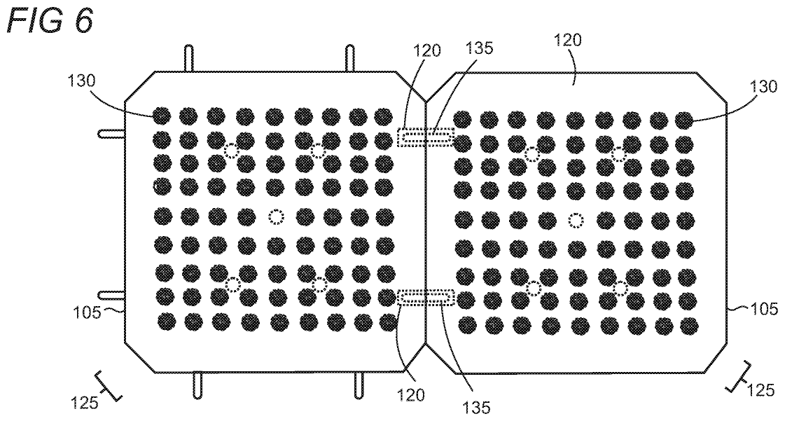

FIG. 6 shows an example of connected flower panels 105 that are filled with flowers to create an aesthetic appearance of a flower wall. The connector peg 135 is inserted into both of the adjacently positioned and opposing receptacles 120 on the respective flower panels, to thereby provide a sturdy and combined appearance of the flower wall. Multiple other flower panels can be connected to the flower panels in FIG. 3 (e.g., the top, bottom, and left or right sides) by similarly inserting connector pegs into each respective receptacle. The connector pegs and holes used to connect the two flower panels together are shown in broken lines to illustrate their presence below the panels.

The number and positioning of the shafts and pegs utilized may be adjusted based on various factors. For example, larger shafts and receptacles may call for a lesser number of shafts, whereas smaller shafts and receptacles may call for a greater number of shafts. Furthermore, the weight of arranged flowers on the panels of the floral arrangements created and the specific flower panels utilized can also affect the number, size, and shape of shafts and connector pegs utilized. depend on the overall weight of the floral arrangement

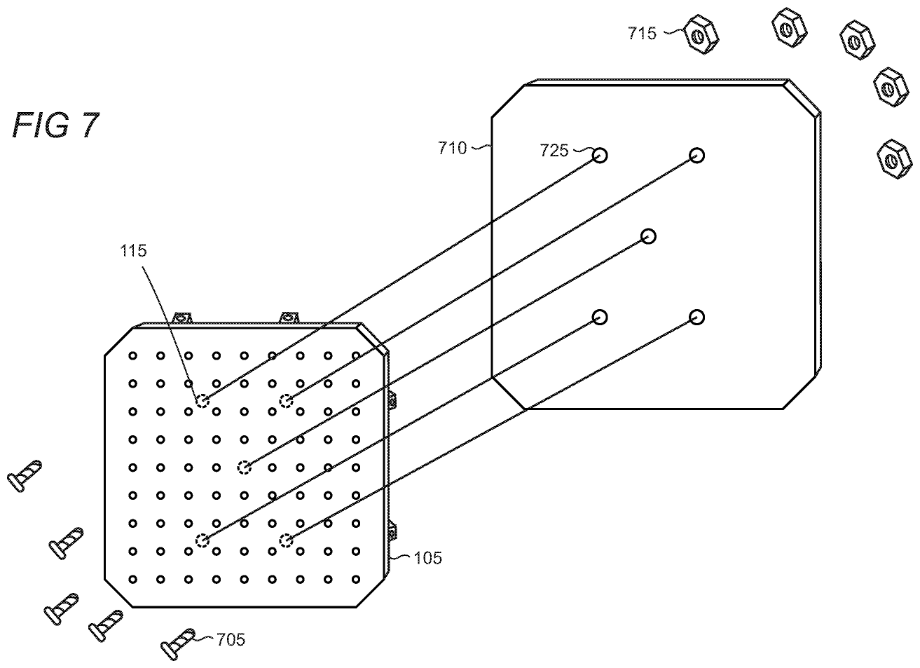

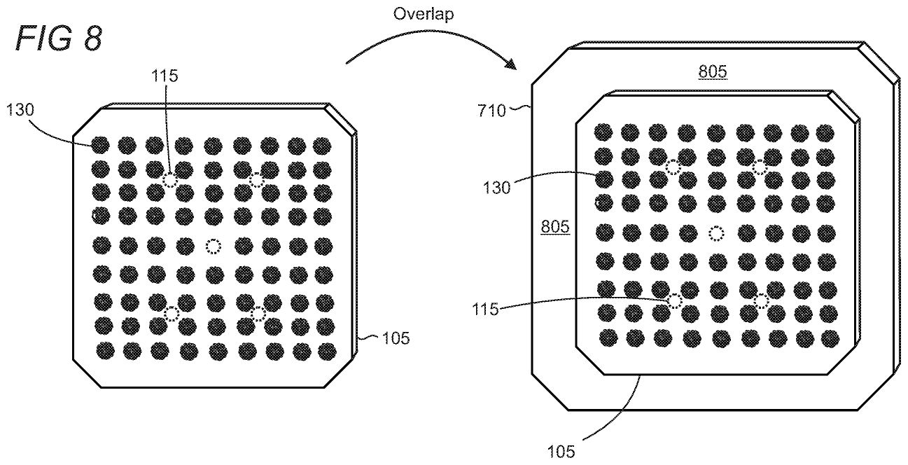

FIG. 7 shows an illustrative representation in which the flower panel 105 can be secured to an adapter panel 710 using bolts 705 and nuts 720 through aligned connector openings 115 and 725. As shown in FIG. 8, additional surface area on the adapter panel is available when the flower panel overlaps and is connected with the adapter panel. This additional surface area around a perimeter of the flower panel provides room for grabbing and handling the flower panel during transportation. In typical implementations, the flower panel is designed to exhibit an arrangement of flowers and may not have a large outer surface area for handling. The adapter not only provides portability for the flower panels, but also provides an additional layer of protection to the flowers during transportation by shifting a user's hands away from the flowers. Thus, during transportation the user can grab the available surface area on the adapter panel instead of the flower panel to thereby reduce inadvertent damage on the flowers.

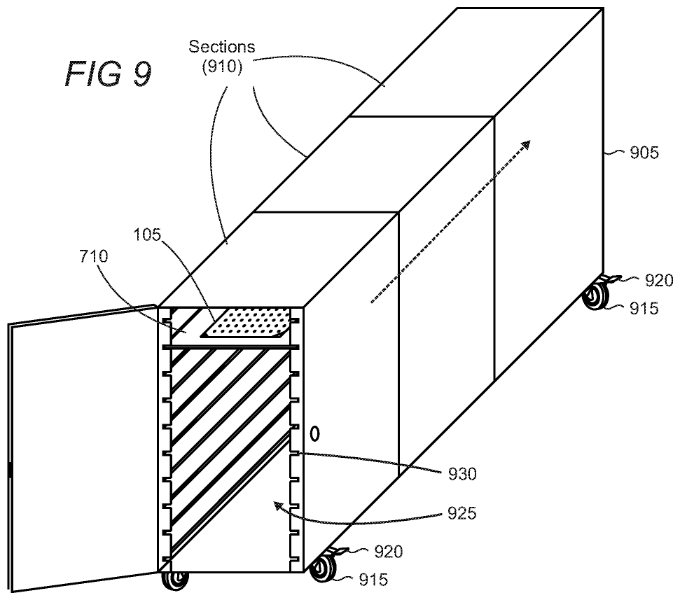

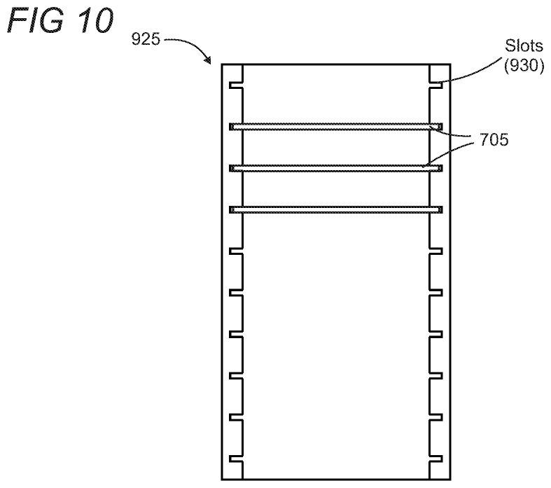

FIGS. 9 and 10 show illustrative representations in which a delivery cage 905 can be utilized to store and transport units of flower panels 105 and adapters 710 when secured together (FIGS. 7 and 8) (flower panels secured to adapters are hereinafter referred to as “panel units”). The delivery cage's rack system 925 includes a series of vertically aligned slots 930 into which the panel units insert and can be pushed back to other sections 910, if present.

For example, the delivery cage can include multiple sections 910 that can each be used to store a series of panel units, for example, three different sections shown in FIG. 9. The panel units may be inserted in the front and be pushed to the rear of the delivery cage as illustratively represented by the broken line arrow. While three different sections are shown in FIG. 9, more or less sections can also be utilized, such as one, two, four, etc. The delivery cage 905 has wheels 915 on which the delivery cage can station and be used for transporting the delivery cage and its contents (i.e., panel units). The wheels include brakes 920 to prevent the delivery cage from moving especially when its filled with multiple flower panels.

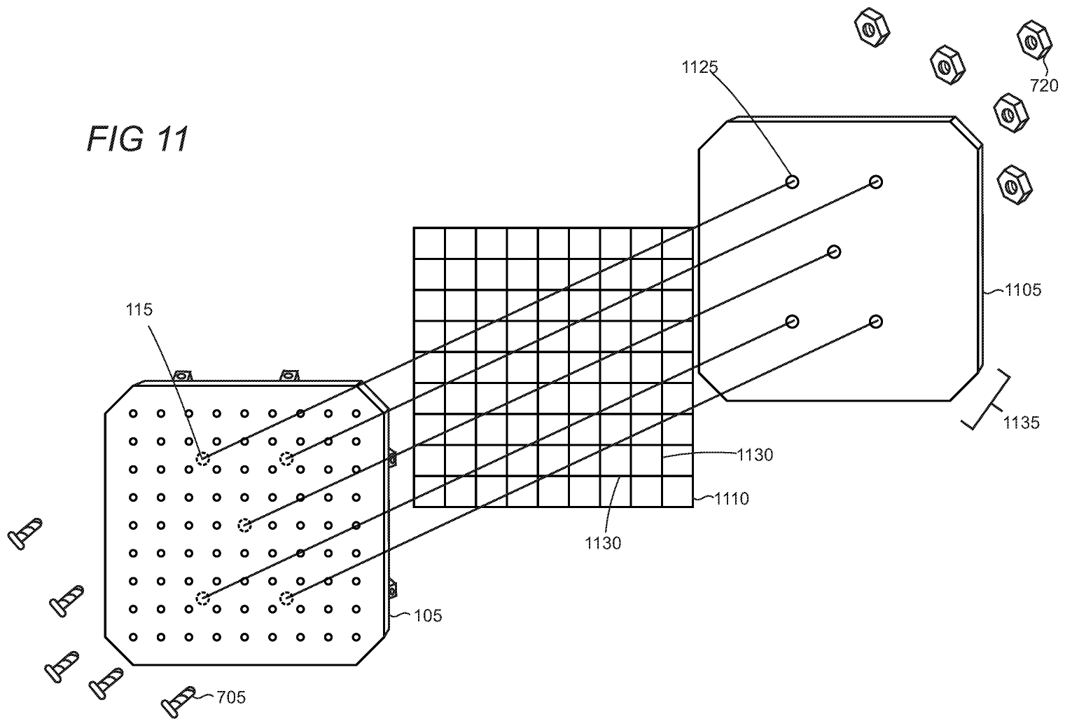

When the panel units are delivered to their destination via the delivery cage 905, the flower panels can be detached from the adapter panels and set-up for display. FIG. 11 shows an illustrative representation in which the flower panel 105 can be assembled with a structural panel 1110 and then fastened and secured to a support panel 1105 that is positioned on a rear of the structural panel for support. The structural panel is made up of a series of individual grid elements 1130 that run up and down or left to right to create a wire grid panel. Similar to the cutouts for the flower panels' edged corners 125, the support panel likewise includes edged corners 1135 that are cut-out to accommodate the connector (not shown) that connects multiple structural panels together, as discussed in greater detail below.

The composition of the flower panel and support panel may depend on a given implementation, and can be comprised of wood, metal (e.g., titanium, steel), or plastic. For example, the materials used can vary based on the overall size of the wall (e.g., larger walls may require stronger materials and smaller walls may use relatively weaker materials) and/or the aesthetic appearance desired. The structural panels may be comprised of some metal (e.g., copper, steel, titanium) to provide the overall skeletal structure to the flower wall, but plastic or other suitable material can also be utilized.

One or more bolts 705 (not drawn to scale) can be inserted into the connection holes 115, extend through the openings in the structural panel 1110, fastened to the receiving holes 1125 of the support panel 1105, and then secured in place via a nut 720. In typical implementations, the bolts can be threaded into threaded receiving holes 1125, however, other fastening mechanisms are also possible. For example, a clamp can be utilized to clamp the flower panel, support panel, and structural panel together, nails can be used to secure the flower panel to the support panel, and other types of fastening mechanisms. One or more fastening mechanisms can be used depending on the specific implementation. While the structural panel provides the overall structure for the floral arrangements, the support panel provides the support to hold up the flower panels.

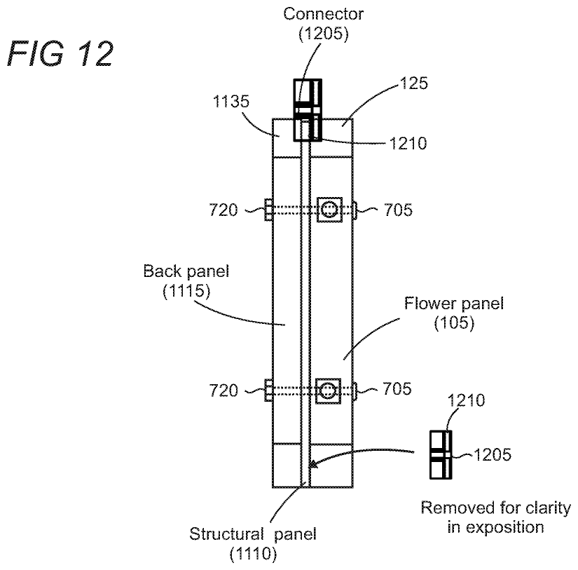

FIG. 12 shows an illustrative side view representation in which the flower panel 105, support panel 1105, and structural panel 1110 are assembled together using the bolts 705 and nuts 720. The broken lines of the bolts representatively illustrate the bolts extending through each panel. A connector 1205 is utilized in the modular flower wall system to connect multiple structural panels 1110 together and thereby create the structural support for the entire flower wall system. That is, multiple structural panels can be connected together to thereby enable multiple flower panels to be placed laterally adjacent to each other (e.g., side by side as shown in FIG. 6). In typical implementations, the connectors may be comprised of a plastic material, but other materials are also possible, such as metal (e.g., titanium, steel, etc.), wood, and other materials suitable for the present implementation.

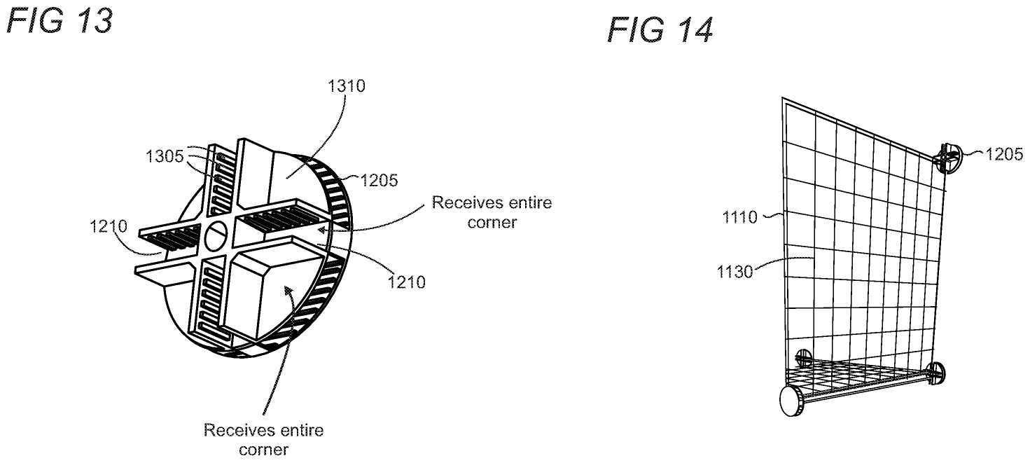

FIGS. 13, 14, and 15 show illustrative representations in which the connector 1205 is implemented to connect structural panels 1110 together for the structural support of the flower wall arrangement. The connector includes receptacles 1210 into which the individual grid elements 1130 of the structural panels are inserted, typically at the corner of the structural panels. There are multiple different ways in which the versatility of the connectors can be realized. For example, a structural panel's corner can rest in a single receptacle 1210 or a right angle opening 1310 in which the outside portions of the structural panel rests against and corresponds to the right angle formed by the connector. In situations in which a grid structural panel is used and there is no defined corner, the structural panel can laterally insert into two perpendicular receptacles 1210 simultaneously (i.e., a vertical receptacle and the adjacent horizontal receptacle).

The cutouts for the flower panel edged corner 125 and support panel edged corner 1135 are present in the structure of the respective panels to accommodate the connector 1205, as illustratively represented in FIG. 12. In some implementations, the connector may alternatively or additionally be a magnet system to which the structural panels can engage.

FIG. 14 illustratively shows corners of a structural panel inserted into the respective receptacles 1210 of the connector 1205. The connector includes ridges 1305 (FIG. 13) which further secures the wire elements 1130 therein and prevent the wire element from inadvertently releasing. The ridges may be plastic, metal, or, in some implementations, may be a rubber material to provide grip against the wire elements.

In typical implementations, the structural panels may initially be assembled to create the structural support for the flower panels 125 and the overall design of the floral arrangement. The number of structural panels assembled will depend on the desired arrangement for the event so that a number of desired flower panels or measured size of the desired flower wall will decide the number of structural panels to use and connect.

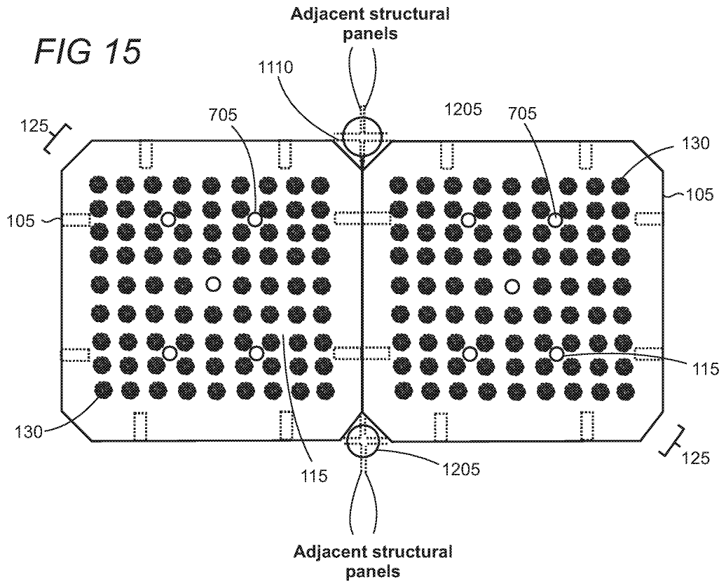

FIG. 15 shows an illustrative representation in which two structural panels 1110 are connected together using the connectors 1205. The individual grid elements 1130 of the structural panels are positioned against the right angle openings 1310 (FIG. 13) to thereby connect the structural panels together and form the backbone structure of the flower wall arrangement. The flower panels 105 are connected to the respective structural panels 1110 and support panels 1105 (not shown) (FIGS. 11 and 12). While FIG. 15 depicts the structural panels using the right angle openings 1310 of the connector 1205, in other implementations, a re-orientation of the connector can enable the structural panel to insert and rest into a respective receptacle 1210. For example, a perpendicularly arranged flower panel may engage with a receptacle 1210 on the connector in the design shown in FIG. 15.

While two flower panels are assembled together with respective structural panels and support panels depicted in FIG. 15, any number of sets of panels can be assembled. For example, a primary flower panel (i.e., an initial flower panel attached to a structural panel) can have a number of secondary flower panels around it, such as laterally to the left, right, top, and bottom. Furthermore, secondary flower panels can be positioned in front of and perpendicularly to the primary flower panel since the connectors have the receptacles in addition to the right angle openings. Arranging the flower panels in a perpendicular manner can create greater customization to the floral arrangements, such as partially encasing a couple during a wedding ceremony. The multiple receptacles and right angle openings are in place so that the use of the connector 1205 is dynamic, versatile, and user-friendly.

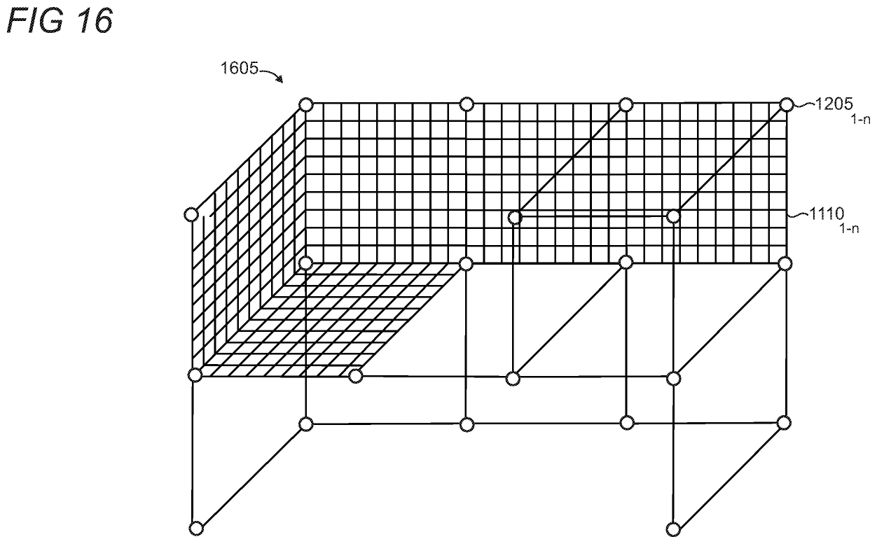

FIG. 16 shows an illustrative representation in which multiple structural panels 1110 are connected together using connectors 1205 to create a mesh grid cage 1605 for the floral arrangements. The grid elements 1130 from some of the structural panels are removed and the flower panels are not shown for clarity in exposition and to show exemplary arrangements of the structural panels. The flower panels 105 and support panels 1105 can be assembled on each respective structural panel to feature a flower wall arrangement. The flower panels can be featured at any location where a structural panel is placed. Thus, the flower panels can face inward or outward at any given structural panel.

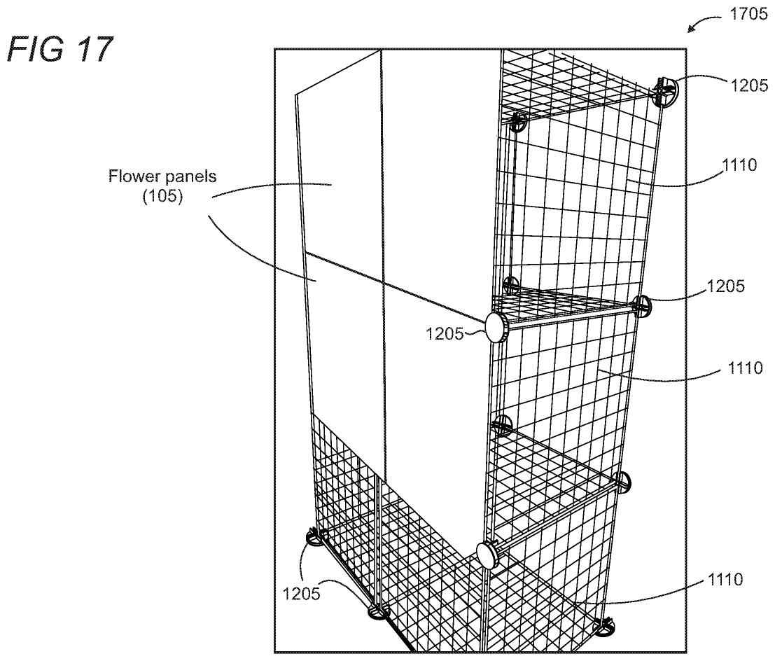

FIG. 17 shows an illustrative representation of an assembled grid cage 1705 with multiple flower panels attached to the various structural panels. This is one set-up in which multiple structural panels are arranged to exhibit a series of flower panels for an event. Additional or less rows and columns can be set-up depending on the scenario, such as the desired size or available real estate. As shown, the structural panels can be arranged on the floor as well to provide a base for the entire structure. Furthermore, the connectors 1205 can likewise be positioned in various orientations as depicted in FIG. 17, such as flat on the ground (facing upward) and in opposing directions to lock in both sides of a respective structural panel. This enhances the dynamicity of the modular flower adapter system such that a user can orient and arrange the pieces in various ways based on their needs and specific implementations.

Various exemplary embodiments are disclosed herein for a modular flower panel adapter system. In one example is a modular flower panel adapter system, comprising: a flower panel having a front side and a rear side and flower holes which extend from the front side to the rear side to receive respective flower stems, wherein the flower panel further includes connection holes that extend from the front side to the rear side; and a support panel positioned on the rear side of the flower panel and to which the flower panel fastens to secure the flower panel to display heads of flowers arranged on the front side of the flower panel.

Another example further includes a primary structural panel which is positioned between the flower panel and the support panel. Another example further includes one or more bolts which extend from respective connection holes in the front panel, through the primary structural panel, and secures to corresponding holes in the support panel. As another example, the flower panel, primary structural panel, and support panel each form a plane and run parallel to each other. As another example, the primary structural panel includes a series of individual wire elements that run in two directions and form a grid. Another example further includes: a secondary structural panel positioned laterally adjacent to the primary structural panel; a connector positioned at least partially in between the primary structural panel and the secondary structural panel and which connects the primary structural panel and the secondary structural panel together. As another example, the connector includes receptacles which respectively receive wire elements from the primary structural panel and the secondary structural panel. In another example, the connector is positioned on one or more corners of the primary structural panel. In another example, the flower panel includes one or more receptacles on lateral sides thereof to connect the flower panel to another flower panel using a connector peg that connects to receptacles on both flower panels, in which the lateral sides are positioned between the front and rear sides. In another example, one or more corners of the flower panel are cut out to accommodate a connector. As another example, one or more corners of the support panel are cut out to accommodate the connector.

In another exemplary embodiment, a modular flower panel adapter system, comprises: an initial flower panel having a front side and a rear side and flower holes which extend from the front side to the rear side to receive respective flower stems, and wherein a shaft is attached to a rear of the flower panel, the shaft having a receptacle that is positioned at an edge of the initial flower panel; a peg inserted into the shaft's receptacle; an initial structural panel positioned adjacent to the shaft on the rear of the flower panel; and an initial support panel positioned adjacent to the structural panel such that the initial flower panel, the structural panel, and the support panel are in a stacked position relative to each other, and wherein each panel is fastened together. Another example further includes a secondary flower panel which likewise includes a shaft with a receptacle attached to a rear side, in which the secondary flower panel's receptacle receives an opposite end of the peg inserted into the initial flower panel's receptacle. As another example, the shaft on the initial flower panel extends from one edge of the flower panel to an opposite edge. As another example, a short shaft is arranged perpendicular to the shaft and extends from the shaft to another edge on the initial flower panel. Another example further includes a secondary structural panels that connect to the initial structural panel using a connector. In another example, the connector includes one or more receptacles that receive respective portions of the initial and secondary structural panels to connect them together. In another example, the receptacles in the connectors have ridges. As another example, the connector is symmetrical.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A modular flower panel adapter system, comprising:
a flower panel having a front side and a rear side and flower holes which extend from the front side to the rear side to receive respective flower stems, wherein the flower panel further includes connection holes that extend from the front side to the rear side; and
a support panel positioned on the rear side of the flower panel and to which the flower panel fastens to secure the flower panel to display heads of flowers arranged on the front side of the flower panel.

2. The modular flower panel adapter system of claim 1, further comprising a primary structural panel which is positioned between the flower panel and the support panel.

3. The modular flower panel adapter system of claim 2, further comprising one or more bolts which extend from respective connection holes in the front panel, through the primary structural panel, and secures to corresponding holes in the support panel.

4. The modular flower panel adapter system of claim 3, wherein the flower panel, primary structural panel, and support panel each form a plane and run parallel to each other.

5. The modular flower panel adapter system of claim 4, wherein the primary structural panel includes a series of individual wire elements that run in two directions and form a grid.

6. The modular flower panel adapter system of claim 2, further comprising:
a secondary structural panel positioned laterally adjacent to the primary structural panel;
a connector positioned at least partially in between the primary structural panel and the secondary structural panel and which connects the primary structural panel and the secondary structural panel together.

7. The modular flower panel adapter system of claim 6, wherein the connector includes receptacles which respectively receive wire elements from the primary structural panel and the secondary structural panel.

8. The modular flower panel adapter system of claim 7, wherein the connector is positioned on one or more corners of the primary structural panel.

9. The modular flower panel adapter system of claim 1, wherein the flower panel includes one or more receptacles on lateral sides thereof to connect the flower panel to another flower panel using a connector peg that connects to receptacles on both flower panels, in which the lateral sides are positioned between the front and rear sides.

10. The modular flower panel adapter system of claim 1, wherein one or more corners of the flower panel are cut out to accommodate a connector.

11. The modular flower panel adapter system of claim 10, wherein one or more corners of the support panel are cut out to accommodate the connector.

12. A modular flower panel adapter system, comprising:
an initial flower panel having a front side and a rear side and flower holes which extend from the front side to the rear side to receive respective flower stems, and wherein a shaft is attached to a rear of the flower panel, the shaft having a receptacle that is positioned at an edge of the initial flower panel;
a peg inserted into the shaft's receptacle;
an initial structural panel positioned adjacent to the shaft on the rear of the flower panel; and
an initial support panel positioned adjacent to the structural panel such that the initial flower panel, the structural panel, and the support panel are in a stacked position relative to each other, and wherein each panel is fastened together.

12. The modular flower panel adapter system of claim 11, further comprising a secondary flower panel which likewise includes a shaft with a receptacle attached to a rear side, in which the secondary flower panel's receptacle receives an opposite end of the peg inserted into the initial flower panel's receptacle.

13. The modular flower panel adapter system of claim 11, wherein the shaft on the initial flower panel extends from one edge of the flower panel to an opposite edge.

14. The modular flower panel adapter system, wherein a short shaft is arranged perpendicular to the shaft and extends from the shaft to another edge on the initial flower panel.

15. The modular flower panel adapter system of claim 11, further comprising secondary structural panels that connect to the initial structural panel using a connector.

16. The modular flower panel adapter system of claim 15, wherein the connector includes one or more receptacles that receive respective portions of the initial and secondary structural panels to connect them together.

17. The modular flower panel adapter system of claim 16, wherein the receptacles in the connectors have ridges.

18. The modular flower panel adapter system of claim 16, wherein the connector is symmetrical.
